(19) United States
(12) Patent Application Publication
(10) Pub. No.: US 2026/0171891 A1
(43) Pub. Date: Jun. 18, 2026

(54) HIGH-EFFICIENCY AND HIGH VOLTAGE CONVERSION RATIO STEP-DOWN POWER CONVERTER

(71) Applicant: THE INDUSTRY & ACADEMIC COOPERATION IN CHUNGNAM NATIONAL UNIVERSITY (IAC), Daejeon (KR)

(72) Inventors: Young-Kyun CHO, Daejeon (KR); Hyeon-Gyu PARK, Daejeon (KR)

(21) Appl. No.: 19/075,816

(22) Filed: Mar. 11, 2025

(30) Foreign Application Priority Data
Dec. 16, 2024 (KR) 10-2024-0186952

(51) Int. Cl. H02M 1/00

(52) U.S. Cl. CPC H02M 1/0054; H02M 1/0095

(57) ABSTRACT

The present disclosure relates to a step-down power converter including a first switch electrically connected between an input terminal and a first node, a second switch electrically connected between the first node and a second node, a third switch electrically connected between the second node and a switching node, a fourth switch electrically connected between the switching node and a ground node, a first capacitor electrically connected between the first node and the switching node, and a second capacitor electrically connected between the second node and the ground node.

### STATEMENT REGARDING GOVERNMENT SPONSORED RESEARCH OR DEVELOPMENT

This work was supported in part by Korea Basic Science Institute (National research Facilities and Equipment Center) grant funded by the Ministry of Science and ICT (No. RS-2024-00399022); in part by the MSIT (Ministry of Science and ICT), Korea, under the ITRC (Information Technology Research Center) support program (IITP-2024-RS-2024-00436406) supervised by the IITP (Institute for Information & Communications Technology Planning & Evaluation); in part by “Leaders in INdustry-University Cooperation 3.0” Project through the Ministry of Education and National Research Foundation (NRF).

### CROSS-REFERENCE TO RELATED APPLICATION

This application claims priority under 35 U.S.C. § 119 to Korean Patent Application No. 10-2024-0186952, filed on Dec. 16, 2024, in the Korean Intellectual Property Office (KIPO), the disclosure of which is incorporated by reference herein in its entirety.

### TECHNICAL FIELD

The present disclosure relates to a step-down power converter, and more specifically, relates to a power stage of a power converter having a high voltage conversion ratio and improved efficiency, and a method for driving the power stage of the power converter.

### BACKGROUND

Recently, as wearable and portable devices have been developed and techniques for size reduction have rapidly been introduced, small transistors having a size of tens to hundreds of nanometers are essentially required. Due to this change, rated voltages of transistors have been lowered, and low-voltage systems operated at voltages equal to or lower than 5V have been popularly adopted. However, despite popularization of the low-voltage systems, high voltage batteries are still commonly used as power sources. Therefore, it becomes necessary to provide step-down converters for converting a high voltage to a low voltage.

Recently, 3-level buck converters that reduce voltage stress of each transistor are widely used. Since the 3-level buck converters provide lower voltage stress than conventional 2-level buck converters, transistors having a smaller size can be used. In addition, the 3-level buck converters have an advantageous structure in reducing a switching loss. However, since a large number of switches has to be driven, complicated driving circuits are required, and difficulties in design and manufacturing the 3-level buck converters increase due to complexity of driving circuits.

In addition, when the 3-level buck converters have a high voltage conversion ratio, an inductor ripple current significantly increases, and a conduction loss also increases. This phenomenon causes a problem that power conversion efficiency in an overall system is reduced. Power converter circuits having various structures have actively been studied to improve this problem.

### SUMMARY

The present disclosure aims to solve problems of a conduction loss and a switching loss of 3-level buck converters in the related art and to reduce circuit complexity while implementing a high voltage conversion ratio.

In addition, the present disclosure aims to provide a power converter capable of maintaining efficiency even under a light load condition.

However, technical aspects to be achieved by embodiments are not limited to technical aspects described above, and other technical aspects may exist.

A step-down power converter according to one embodiment of the present disclosure may include a first switch electrically connected between an input terminal and a first node, a second switch electrically connected between the first node and a second node, a third switch electrically connected between the second node and a switching node, a fourth switch electrically connected between the switching node and a ground node, a first capacitor electrically connected between the first node and the switching node, and a second capacitor electrically connected between the second node and the ground node.

According to the present disclosure, a switching loss and a conduction loss can be effectively reduced by maintaining current distribution and capacitor balance.

In addition, the present disclosure can greatly improve performance and reliability of a power converter by providing a high voltage conversion ratio and stable efficiency even under a light load.

### BRIEF DESCRIPTION OF THE DRAWINGS

FIG. 1 is a circuit diagram showing a 3-level converter power stage in the related art.

FIG. 2 is a circuit diagram showing a step-down power converter having a high voltage conversion ratio and efficiency according to one embodiment of the present disclosure.

FIG. 3A is a circuit diagram showing a charging operation of the step-down power converter according to one embodiment of the present disclosure.

FIG. 3B is a circuit diagram showing a discharge operation of the step-down power converter according to one embodiment of the present disclosure.

FIG. 4A is a circuit diagram showing how the step-down power converter is operated during an ON-state in a situation where a reverse current is generated.

FIG. 4B is a circuit diagram showing how the step-down power converter is operated during an OFF-state in the situation where the reverse current is generated.

FIG. 5 is a graph showing efficiency depending on a load current of a conventional 3-level power converter and a power converter according to one embodiment of the present disclosure.

### DETAILED DESCRIPTION

Hereinafter, embodiments of the present disclosure will be described in detail with reference to the accompanying drawings so that those skilled in the art can easily practice the present disclosure. The present disclosure may be modified in various ways, and may adopt various embodiments. Specific embodiments will be shown as examples in the drawings, and specifically described in the detailed description. Meanwhile, the present disclosure is not limited to specific embodiments, and it should be understood that the present disclosure includes all modifications, equivalents, or substitutions which are included in the concept and technical scope of the present disclosure.

In order to clearly describe the present disclosure, components irrelevant to the description will be omitted in the drawings, and similar drawing reference numerals will be assigned to similar components throughout the specification. In addition, when the present disclosure is described with reference to the drawings, even when components are indicated by the same name, the drawing number may vary depending on the drawing, and the drawing number is provided merely for convenience of description. A concept, a feature, a function, or an advantageous effect of each component is not limited and interpreted by the corresponding drawing number.

In describing each drawing, similar reference numerals will be used to refer to similar components. Although terms of first, second, and the like may be used to describe various components, the components should not be limited by the terms. The terms are used only to distinguish one component from another component. For example, without departing from the scope of the present disclosure, a first component may be referred to as a second component, and similarly, the second component may also be referred to as the first component. A term of “and/or” includes any combination of a plurality of related listed items or any item of the plurality of related listed items.

Unless otherwise defined, all terms used herein, including technical or scientific terms, have the same meaning as terms commonly understood by a person of ordinary skill in the art to which the present disclosure belongs.

Terms defined in commonly used dictionaries should be interpreted as having a meaning consistent with a meaning in the context of the related art, and should not be interpreted in an idealized or overly formal sense, unless expressly defined in the present application.

Throughout the specification, when an element is “connected” to another element, the description includes not only a case where the elements are “directly connected”, but also a case where the elements are “electrically connected” by another element interposed therebetween. In addition, when an element “includes” a certain component, unless specifically contrarily described, the description means that the element does not exclude other components and may further include other components. It should be understood that the element does not exclude in advance a possibility that one or more other features, numbers, steps, operations, components, parts, or combinations thereof are present or added.

In the present specification, a ‘part’ or a ‘module’ includes a unit realized by hardware or software, and a unit realized by using both the hardware and the software. One unit may be realized by using two or more pieces of the hardware, and two or more units may be realized by one piece of the hardware.

Before a step-down power converter according to embodiments of the present disclosure is described, a 3-level converter power stage in the related art will be described.

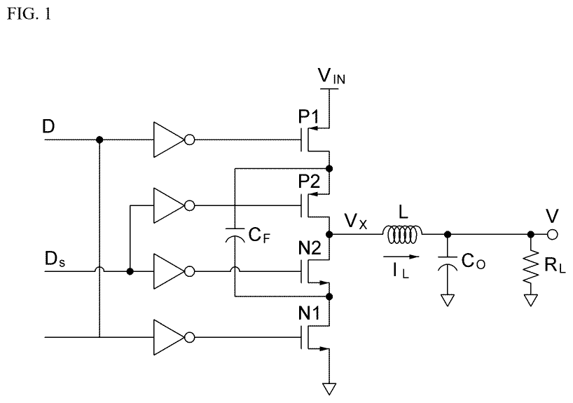

FIG. 1 is a circuit diagram showing the 3-level converter power stage in the related art.

Referring to FIG. 1, a power stage of a 3-level buck converter uses four switches (P₁, P₂, N₁, and N₂) and one capacitor (C_{F}) to implement a step-down operation. These four switches are controlled by driving signals D and Dₛ to which a 180-degree phase shift is applied. Although the 3-level buck converter uses additional switches and capacitors, compared to a general buck converter, the 3-level buck converter effectively reduces a switching loss in such a manner that a voltage of a switching node (Vₓ) is reduced to V_{IN}/2 by utilizing a voltage charged in the capacitor. In addition, since the voltage of the switching node is reduced, a magnitude of a current flowing in an inductor decreases, and a conduction loss is also reduced. As a result, the 3-level buck converter provides high power conversion efficiency.

However, in the 3-level buck converter, two switches are always turned on at the same time between an input voltage (V_{IN}) and an output voltage (V_{OUT}) during all operation periods. Consequently, a large conduction loss occurs due to ON-resistance of each switch. In order to solve this problem, a hybrid converter structure has been proposed. However, this structure has the following limitations. Since voltage stress of each transistor is not constant, additional design changes are required, and more transistors are needed. Accordingly, a driving method becomes complicated.

In order to reduce the voltage of the switching node in the 3-level buck converter to ½, compared to the general buck converter, a voltage in both ends of the C_{F} needs to be always be maintained at V_{IN}/2. When the voltage of the C_{F} becomes unstable, the voltage of the switching node may fluctuate, and thus, voltage stress applied to each transistor may increase. In order to solve this problem, various techniques such as constant on-time duty control and capacitor balancing techniques have been proposed. However, these techniques require complicated control methods and additional circuit configurations.

As described above, the 3-level buck converter has an advantage in that high power conversion efficiency is achieved by reducing the voltage of the switching node. However, since the 3-level buck converter is provided, basically based on a buck converter, a power conversion ratio is limited to D (duty ratio). In an application field requiring a high step-down voltage, as the D decreases, control accuracy becomes more important. Therefore, it is essential to adopt a circuit structure which can provide a higher power conversion ratio than the D.

The present disclosure proposes a power stage structure which can reduce a switching loss by lowering the voltage of the switching node to half of the input voltage (V_{IN}/2) and which can reduce a conduction loss by reducing the number and currents of switches used in a conduction path. In particular, the present disclosure introduces an additional capacitor and a simple control method to solve a problem of capacitor balancing, which is a chronic problem occurring in the 3-level power converter. This method may be easily implemented, compared to conventional complicated control techniques, and may provide stable voltage balancing.

In addition, the power stage structure proposed in the present disclosure is designed to implement a higher voltage conversion ratio than the conventional buck converter by setting a voltage conversion ratio of the buck converter to D/2 (here, D is a ‘duty ratio’). This design may provide more excellent performance than the conventional techniques, in an application environment requiring high step-down voltage conversion.

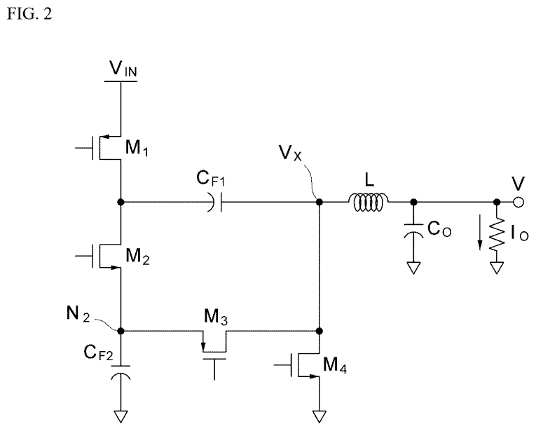

Hereinafter, an operation of the step-down power converter according to embodiments of the present disclosure will be described in more detail with reference to FIGS. 2 to 4.

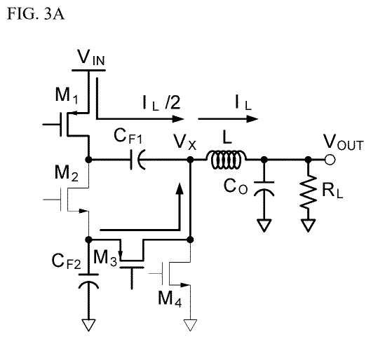

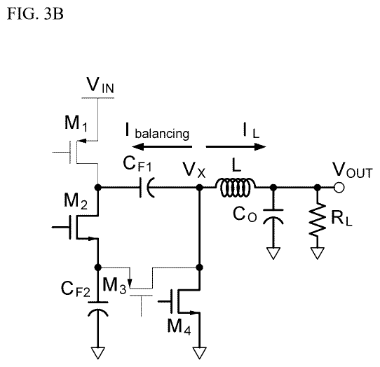

FIG. 2 is a circuit diagram showing a step-down power converter having a high voltage conversion ratio and efficiency according to one embodiment of the present disclosure, and FIGS. 3A and 3B are circuit diagrams showing charging and discharging operations of the step-down power converter according to the embodiment of the present disclosure.

Referring to FIGS. 2, 3A, and 3B, the power stage may include four switches (M₁, M₂, M₃, and M₄) and two capacitors (C_{F1} and C_{F2}), and each switch may include an NMOS transistor or a PMOS transistor. Both the NMOS and the PMOS have three main terminals including a gate, a drain, and a source. In the NMOS, a channel is formed when a positive voltage is applied to the gate, and a current flows between the drain and the source. Due to high electron mobility, a switching speed is fast, and power is efficient. On the other hand, in the PMOS, a channel is formed when a negative voltage is applied to the gate, the PMOS shows low power consumption. In CMOS circuit design, the PMOS is used complementarily with NMOS. Due to these characteristics, the NMOS is suitable for a high-speed circuit requiring fast switching, and the PMOS is suitable for low-power design or a CMOS structure. However, both of these are applicable in various ways, depending on a design purpose.

In the embodiments in FIGS. 2 to 4, a two-step operation method is adopted unlike a four-step operation method adopted by the conventional 3-level buck converter. As shown in FIGS. 2 to 4, the present disclosure is designed to adopt the two-step operation method, and includes an ON-state and an OFF-state. In each operation stage, power may be efficiently converted through a combination of flying capacitors (C_{F1} and C_{F2}) and switches (M₁, M₂, M₃, and M₄). Here, the ON-state means a state where the switches M₁ and M₃ are turned on. In this case, the flying capacitors C_{F1} and C_{F2} are charged to V_{IN}/2, which is half of the input voltage (V_{IN}). Two current paths are formed through the switches M₁ and M₃. A first path passes through the M₁ and the C_{F1}, and a second path passes through the C_{F2} and the M₃. In the second path, C_{F2} is operated as an additional voltage source to stably maintain a voltage.

In the OFF-state, the switches M₁ and M₃ are turned off, and the switches M₂ and M₄ are turned on. The first path is connected to an output node through the switch M and an inductor (L) to form the output voltage (V_{OUT}). The first path is a discharge path, and may stably maintain the output voltage. The second path passes through the M₄, the C_{F1}, the M₂, and the C_{F2}, and plays a role in maintaining the voltages of the two flying capacitors (C_{F1} and C_{F2}) in a balanced manner. A capacitor balance path (C_{F2}-M₂-C_{F1}-M₄) formed in this path removes a voltage difference of the flying capacitors so that the two capacitors maintain the same voltage.

The flying capacitors C_{F1} and C_{F2} used in the present disclosure divide the input voltage (V_{IN}) into half, and charge each capacitor with the divided voltage. In this case, the C_{F1} and the C_{F2} are charged to V_{IN}/2 in a steady state, the voltage of the switching node (Vₓ) is also set to V_{IN}/2. In the OFF-state, the C_{F1} and the C_{F2} may be connected in parallel to remove a voltage offset. Through this configuration, the voltage of the flying capacitor may be maintained in a balanced state, and stability of the power converter may be secured.

In addition, the present disclosure may additionally use a startup circuit. The startup circuit helps the flying capacitor to quickly achieve a normal operation state by charging the flying capacitors C_{F1} and C_{F2} with the voltage of V_{IN}/2 in an initial state. The startup circuit may be used to stably charge the flying capacitor when power is not sufficiently supplied in the initial state.

Specifically, referring to FIG. 3A, when the switch M₁ and the switch M₃ are turned on in the ON-state, two independent current paths may be formed. A first current path is a path through which the current flows to the flying capacitor C_{F1} after passing through the switch M₁, and this path is formed to charge the flying capacitor C_{F1} with a portion of the input voltage (V_{IN}). A second current path is a path through which the current flows to the ground after passing through the flying capacitor C_{F2} and the switch M₃, and the V_{IN}/2 voltage stored in the flying capacitor C_{F2} is utilized as an additional voltage source. In this process, the flying capacitors C_{F1} and C_{F2} are connected in series between the input voltage (V_{IN}) and the ground, and the voltage of each capacitor is always maintained at V_{IN}/2. As a result, the voltage of the switching node Vₓ may be stably set to V_{IN}/2. Since the voltage of the switching node Vₓ is limited to half of the input voltage, the switching loss may be significantly reduced, and this configuration may be suitably used in application environments requiring high-efficiency power conversion, such as data centers.

In the ON-state, the current flowing through the switches M₁ and M₃ is reduced by half, compared to the current flowing through the switches of the conventional 3-level buck converter. Specifically, due to the two independent current paths, the current flowing through each of the switch M₁ and the switch M₃ is distributed by half, compared to the conventional structure. This configuration reduces the current concentrated on one switch. The conduction loss caused by the current flowing through the switch is calculated as I²R, and the conduction loss may also be proportionally reduced as the current is reduced.

In FIG. 3A, since the current flowing through each of the switch M₁ and the switch M₃ is reduced by half, compared to the current in the conventional 3-level buck converter, the conduction loss may also be reduced to ½×I²R. On the other hand, in the conventional 3-level buck converter, the current sequentially passes through two switches. Therefore, the conduction loss is calculated as 2×I²R, and the conventional 3-level buck converter shows a high conduction loss of approximately 4 times the conduction loss in the present disclosure.

Referring to FIG. 3B, in the OFF-state, when the switch M₁ and the switch M₃ are turned off, and the switch M₂ and the switch M₄ are turned on, two current paths are formed. In the first current path, the current flows to the output node after passing through the switch M and the inductor L, and the first current path may stably supply the output voltage (V_{OUT}). The second current path is formed by sequentially passing through the switch M₄, the flying capacitor C_{F1}, the switch M₂, and the flying capacitor C_{F2}. This path is operated as a capacitor balance path for maintaining the voltages of the flying capacitors C_{F1} and C_{F2} in a balanced manner, and may maintain the voltage stored in the two flying capacitors at V_{IN}/2.

The flying capacitors C_{F1} and C_{F2} are connected in series during the ON-state, and are each charged with V_{IN}/2. During the OFF-state, the flying capacitors C_{F1} and C_{F2} may be connected in parallel to remove the voltage offset.

A voltage conversion ratio according to the embodiment of the present disclosure may be set to D/2 by utilizing a duty cycle, and may be derived, based on a voltage-second balance law of the inductor. The voltage-second balance law means that an average value of the voltages applied to the inductor for one period when the inductor is operated in a steady state has to be surely 0.

In the ON-state, the average voltage applied to the inductor in a state where the switch M₁ and the switch M₃ are turned on is expressed as (V_{IN}/2−V_{OUT})D·Ts. Here, V_{IN} is the input voltage, V_{OUT} is the output voltage, D is the duty cycle, and Ts is a duration of one period. In the OFF-state, the switch M₂ and the switch M₄ are turned on. In this case, the average voltage applied to the inductor may be expressed as −V_{OUT}·(1−D)Ts. The voltages generated in the ON-state and the OFF-state have to offset each other. In this manner, the inductor may be operated in a steady state. Since the two voltages have to be equal, the voltage conversion ratio may be expressed as V_{OUT}/V_{IN}=D/2.

This voltage conversion ratio is calculated, based on operation characteristics of the flying capacitor and the switching node which are used in the present disclosure. The flying capacitor is always charged with V_{IN}/2, which is half of the input voltage V_{IN}, and a voltage range of the switching node is limited to 0 to V_{IN}/2. Since the voltage range of the switching node is limited, the switching losses may be reduced by half or more.

A structural feature of the present disclosure in which the voltage of the switching node is limited to V_{IN}/2 provides a basis for implementing a higher voltage conversion ratio, compared to the conventional buck converter structures. Whereas the voltage conversion ratio in the conventional buck converters is limited to D, the buck converter structure according to the embodiment of the present disclosure may be efficiently operated in application fields requiring high step-down voltage conversion through the voltage conversion ratio of D/2.

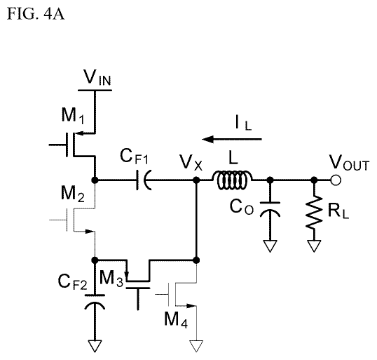

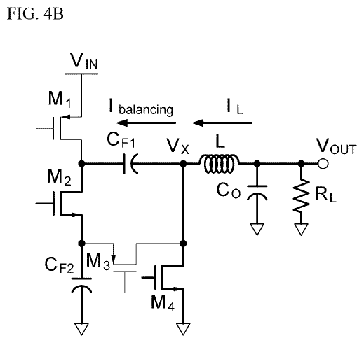

FIGS. 4A and 4B are circuit diagrams showing how the step-down power converter is operated during the ON-state and OFF-state in a situation where a reverse current is generated.

Referring to FIGS. 4A and 4B, a discontinuous conduction mode (DCM) refers to a state where the current flowing in the inductor is zero or turns negative, and may generally occur under conditions that a load is reduced or a demand amount of the output voltage is lowered. This state may present a major technical aspect to be achieved to ensure a stable operation while efficiency of the power converter is maintained. The conventional buck converter uses a method for detecting a time at which the inductor current reaches zero in a DCM state and preventing a reverse current by turning off a low-side transistor. Although this method may prevent a loss and a circuit malfunction which are caused by the reverse current, this method has a disadvantage in that design complexity increases since a control circuit and a detection device are additionally required.

The embodiment of the present disclosure is designed to improve efficiency without additionally requiring the circuit in the DCM state. When the reverse current is generated in the ON-state, the flying capacitor C_{F1} and the flying capacitor C_{F2} are charged, and the reverse current may be utilized to minimize a charge loss which may occur in the ON-state. Specifically, when the reverse current flows to the flying capacitor C_{F2}, the flying capacitor C_{F2} may be operated as an additional voltage source to supplement a role of the existing voltage source. The flying capacitor C_{F2} is charged with V_{IN}/2, which is half of the input voltage, and contributes to stably maintaining the voltage of the switching node. This operation in the ON-state may be used to improve efficiency by utilizing the reverse current to reduce an energy loss of the power converter.

In the OFF-state, the switch M₁ and the switch M₃ are turned off, and the switch M₂ and the switch M₄ are turned on. In this stage, the flying capacitor C_{F1} and the flying capacitor C_{F2} are charged in parallel with the reverse current, and a capacitor balancing path is formed in this process. The capacitor balancing path includes the switch M₄, the flying capacitor C_{F1}, the switch M₂, and the flying capacitor C_{F2}, and may maintain a balanced state by reducing a voltage difference between the flying capacitors. This balancing plays a role in removing a voltage offset accumulated in the flying capacitor C_{F1} and the flying capacitor C_{F2}.

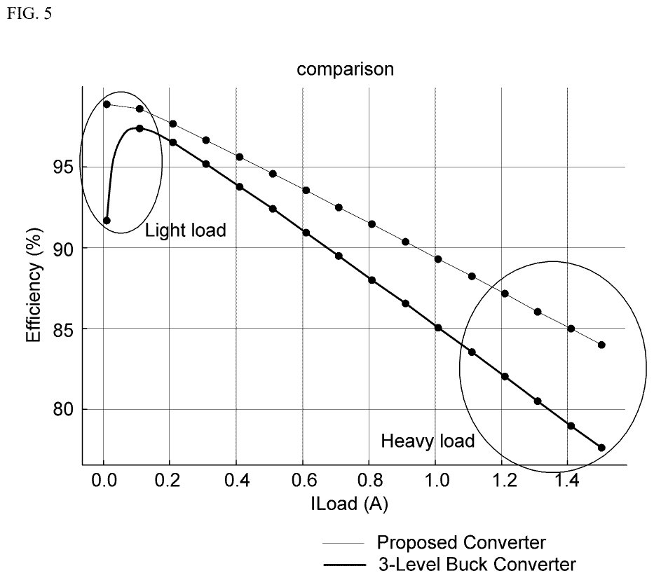

FIG. 5 is a graph showing efficiency depending on a load current of the conventional 3-level power converter and the power converter according to the embodiment of the present disclosure.

Referring to FIG. 5, under a current condition of approximately 10 mA in a light load state, the energy loss caused by the reverse current which may be generated in the conventional 3-level buck converter may be effectively suppressed according to the present disclosure. The reverse current refers to a phenomenon in which the current flows in an input direction instead of a load direction in a power conversion circuit to cause unnecessary charging of the capacitor. This reverse current may be a cause of significantly lowering energy efficiency in the light load state. In order to prevent the energy efficiency from being significantly lowered, the present disclosure may achieve improved efficiency of approximately 7.2% by applying a new design including a reverse current blocking mechanism.

In addition, under a current condition of approximately 1.5 A in a heavy load state, the present disclosure shows improved efficiency of approximately 7.4%, compared to the conventional 3-level power converter. Referring to FIG. 5, it may be understood that an efficiency improvement effect according to the present disclosure becomes more prominent as the load increases.

Although the embodiments have been described above by way of limited examples and drawings, those skilled in the art can perform various corrections and modifications from the description above. For example, proper results may be achieved even when the described techniques are performed in an order different from an order of the described method, and/or components of the described systems, structures, devices, circuits, and the like are combined or assembled in forms different from forms of the described method, or are replaced or substituted by other components or equivalents.

Therefore, other implementations, other embodiments, and equivalents to the appended claims are also included in the scope of the appended claims described below.

What is claimed is:

1. A step-down power converter comprising:
a first switch electrically connected between an input terminal and a first node;
a second switch electrically connected between the first node and a second node;
a third switch electrically connected between the second node and a switching node;
a fourth switch electrically connected between the switching node and a ground node;
a first capacitor electrically connected between the first node and the switching node; and
a second capacitor electrically connected between the second node and the ground node.

2. The step-down power converter of claim 1, wherein each of the first switch, the second switch, the third switch, and the fourth switch is implemented as an NMOS transistor or a PMOS transistor.

3. The step-down power converter of claim 1, further comprising:
an inductor electrically connected between the switching node and an output node;
a capacitor electrically connected between the output node and the ground node; and
a load resistor.

4. The step-down power converter of claim 3, wherein when the first switch and the third switch are turned on and the second switch and the fourth switch are turned off, a first current path passing through the first switch and the first capacitor and a second current path passing through the second capacitor and the third switch are formed.

5. The step-down power converter of claim 4, wherein the second current path is operated as an additional voltage source due to a voltage with which the second capacitor is charged.

6. The step-down power converter of claim 3, wherein when the first switch and the third switch are turned off and the second switch and the fourth switch are turned on, a third current path passing through the fourth switch and the inductor and a fourth current path passing through the fourth switch, the first capacitor, the second switch, and the second capacitor are formed.
